(19) United States
(12) Patent Application Publication
(10) Pub. No.: US 2022/0353063 A1
(43) Pub. Date: Nov. 3, 2022

(54) METHOD FOR VALIDATING OR VERIFYING A FIELD DEVICE

(71) Applicant: Endress+Hauser Process Solutions AG, Reinach (CH)

(72) Inventors: Thomas Alber, Stuttgart (DE); Markus Kilian, Merzhausen (DE); Axel Pöschmann, Basel (CH); Sascha Bihler, Rheinfelden (DE); Simon Merklin, Bahlingen a.K. (DE)

(21) Appl. No.: 17/753,977

(22) PCT Filed: Aug. 20, 2020
(86) PCT No.: PCT/EP2020/073411

§ 371 Date: Mar. 21, 2022

(30) Foreign Application Priority Data
Sep. 20, 2019 (DE) 10 2019 125 417.5

(51) Int. Cl. H04L 9/08; H04L 9/32

(52) U.S. Cl. CPC H04L 9/0825; H04L 9/0877; H04L 9/3247

(57) ABSTRACT

A method for validating a field device is disclosed. The field device includes a plurality of hardware and software modules and is provided with a first cryptographic signature on the manufacturer side. The first cryptographic signature identifies the device manufacturer or the original delivery state of the field device. The origin and integrity of the field device is validated on the customer side using the first cryptographic signature. Once the field device is adapted to a defined machinery, the field device is provided with a second cryptographic signature on the customer side. The second cryptographic signature identifies the adaptations of the field device made on the customer side as a machinery-specific desired state of the field device. At least one validation of the field device is carried out on the customer side using the second cryptographic signature during the period of installation of the field device in the defined machinery.

The invention relates to a method for validating or verifying a field device which determines or monitors a physical, chemical, or biological process variable of a process medium in automation technology.

In automation systems, especially in process automation systems, field devices are often used that serve to detect and/or influence process variables of a medium. The medium itself can be liquid, gaseous, or even solid. Sensors serve to detect process variables, which sensors being used are, for example, integrated into fill level meters, flow meters, pressure and temperature meters, pH redox potential meters, conductivity meters etc. which detect the corresponding process variables of fill level, flow, pressure, temperature, pH value, or conductivity. Actuators such as, for example, valves or pumps serve to influence process variables, via which actuators the flow rate of a fluid in a pipe section or the fill level of a medium in a container can be altered. In conjunction with the invention, all devices which are used in relation to the process and which supply or process information relevant to the process are referred to as field devices. The term “field devices” is also understood to mean remote I/Os, radio adapters, and other components which are arranged at the field level in the process. A variety of such field devices are manufactured and marketed by the Endress+Hauser company.

The field devices are usually connected to a fieldbus. Communication between the field devices and/or with a higher-level unit takes place via at least one of the fieldbus protocols that are customary in automation technology. Increasingly, however, communication is also taking place via Internet protocols.

If an unauthorized intervention is performed at one of the field devices—the field device is thus manipulated—this may lead to considerable disadvantages for the operator of an automation system. In the worst case, the manipulation causes a failure of the production in the corresponding process plant, and/or may lead to personal injury and property damage.

Furthermore, it is critical if the manipulation is performed at a calibratable field device.

In order to ensure that no manipulation of the configuration of a field device takes place, nowadays inventory lists and configuration parameters are checked in a complex comparison procedure. This procedure makes it possible to determine whether the automation system is still in an intended state as desired and defined by the operator. If one takes into account that a few hundred or even thousands of field devices can be used in an automation system, it proves to be extremely difficult to discover additional and/or manipulated field devices via the previously described comparison procedure. Due to this very time-consuming validation method, it is therefore often not performed at all.

Furthermore, a customer has not yet had the opportunity to detect, without a great deal of trouble and “at first glance,” whether only the original components of the manufacturer are installed in a field device; this applies both in the event of the initial delivery but also in a servicing instance, when the field device enters the sphere of a service provider for the purpose of repair. In the context of the invention, original components are understood to mean hardware components, software components such as firmware and application programs, and also the parameter or configuration settings of a field device.

To ensure that the firmware of a field device is not manipulated, it has already become known to associate with the firmware a checksum based on CRC32 (CRC: cyclic redundancy check). This is hereby a code capable of detecting changes in data. Firmware is understood to mean the software embedded in electronic devices. It is usually stored in a flash memory, an EPROM, EEPROM, or ROM, and cannot be exchanged by the user or can only be exchanged with special means or functions. The term derives from the fact that firmware is functionally permanently connected to the hardware. The hardware cannot be used meaningfully without the firmware. Firmware has an intermediate position between hardware and the application software, that is to say the possibly exchangeable programs of a field device. Incidentally, the known authenticity protection is preferably used in calibratable field devices. A solution that provides general manipulation protection for field devices has not as yet become known.

The object of the invention is to specify a simple method for checking the integrity of a field device. A field device is intact within the meaning of the invention when it corresponds in all of its components to the original manufacturer's state upon delivery to the user.

The object is achieved by a method for validating or verifying a field device that determines or monitors a physical, chemical, or biological process variable of a process medium in automation technology, wherein the field device is composed of a plurality of hardware and software modules. On the manufacturer side, the field device is provided with a first cryptographic signature, wherein the signature unambiguously identifies the device manufacturer and/or the original delivery state of the field device, defined by genuine hardware and software/firmware and genuine configuration settings. On the customer side, the origin and/or the integrity of the field device is validated/verified by means of the first cryptographic signature. After the field device has been adapted to a defined application, the field device is provided on the customer side with a second cryptographic signature, wherein the second cryptographic signature unambiguously identifies the adaptations of the field device made on the customer side as an application-specific intended state of the field device. During the duration of the installation of the field device in the defined application, the customer has at any time the possibility of performing a validation or verification of the field device via the second cryptographic signature.

The field device, which is usually of modular design, is provided with the first cryptographic signature, preferably at the end of the production process. The field device consists of hardware components, for example electronic assemblies, and software components such as firmware, application programs, and configuration parameters. This first cryptographic signature unambiguously identifies the manufacturer and/or the original delivery state, and thus the integrity of the corresponding field device.

Upon delivery, this cryptographic signature of the manufacturer or supplier serves to enable the customer/user to validate/verify the origin and integrity of the field device.

If the customer has installed the field device, e.g. in an automation system, the field device is usually adapted to the respective use case or application on the customer side. The field device is configured/parametrized, wherein if applicable the configuration data preset by the manufacturer are changed. The field device is then provided with a second cryptographic signature on the customer side. This signature is, for example, customer-specific, system-specific, device-specific etc. With the second signature, the customer/authorized user thus identifies the intended state of the field device as desired by them.

On the basis of this further signature, the customer can check the integrity of the field device at any time. They can especially check and determine in a simple manner whether changes have been made to the electronic assemblies, the firmware, the software, and/or the configuration data of the field device.

It can thus be checked, using the validation or verification of the field device, whether an actual state of the field device corresponds to the intended state authorized and/or defined by the customer/user, and whether the field device is intact. Furthermore, it can be established in a simple manner, via signature comparison, if an unauthorized change to the hardware and/or software modules of the field device has been attempted or performed.

One embodiment of the method according to the invention provides that the first cryptographic signature and/or the second cryptographic signature are created via an asymmetric cryptosystem consisting of a private key and a public verification key, a public key.

The term “asymmetric cryptosystem” is a generic term for a public key encryption method, public key authentications, and digital signatures. The asymmetric cryptosystem or the public key cryptosystem is a cryptographic method in which, in contrast to a symmetrical cryptosystem, the communicating parties do not need to know a shared secret key. Each user generates their own key pair consisting of a secret part (private key) and a non-secret part (public key). The public key makes it possible for anyone to encrypt data for the owner of the private key, to check their digital signatures, or to authenticate them. The private key enables its owner to decrypt data encrypted with the public key, to generate or authenticate digital signatures.

With the invention and its embodiments, it is possible to reliably ascertain, via a simple, automatable signature check, whether the modules of a field device are genuine and whether a field device is still in an intended state as desired and authorized by the customer. Field devices that do not have a valid signature can be automatically ascertained and optionally rejected.

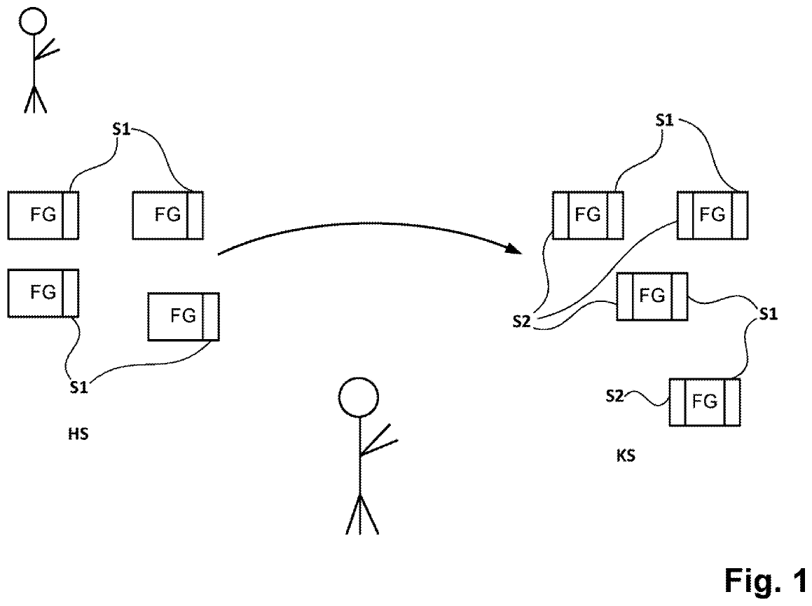

The method according to the invention for validating or verifying a field device FG which determines or monitors a physical, chemical, or biological process variable of a process medium in automation technology is explained in more detail using FIG. 1. FIG. 1 shows a plurality of field devices FG on the manufacturer side HS and on the customer side KS. Each of the field devices FG is composed of a plurality of hardware and software modules. On the manufacturer side HS, the field device FG is provided with a first cryptographic signature S1 before delivery to the customer. The first cryptographic signature S1 unambiguously identifies the device manufacturer and/or the original delivery state of the field device FG. The field device has guaranteed genuine hardware and software/firmware and genuine configuration settings.

On the customer side KS, the origin and integrity of the field device FG are validated/verified by a service employee S by means of the first cryptographic signature S1.

Usually, a new configuration is effected on the customer side in order to adapt the field device FG optimally to a defined application in which it is installed. The field device FG is next provided on the customer side KS with a second cryptographic signature S2 by a service employee S. The second cryptographic signature S2 unambiguously identifies the adaptation of the field device FG performed on the customer side as an application-specific intended state of the field device FG. This gives the customer the option of using the second cryptographic signature S2 to establish at any time—even during operation of the field device FG in the defined application—whether the field device is still in its validated and verified intended state. Since the validation/verification process can be automated, an actual/intended check is also possible without a great expenditure of time, even during operation of the field device FG.

1-6. (canceled)

7. A method for validating or verifying a field device which determines or monitors a physical, chemical, or biological process variable of a process medium in automation technology, wherein the field device is composed of a plurality of hardware and software modules,
wherein on the manufacturer side the field device is provided with a first cryptographic signature; wherein the first cryptographic signature unambiguously identifies the device manufacturer and/or the original delivery state of the field device, defined by genuine hardware and software/firmware and genuine configuration settings;
wherein the origin and integrity of the field device is validated/verified on the customer side using the first cryptographic signature; wherein, after an adaptation of the field device to a defined application, the field device is provided on the customer side with a second cryptographic signature; wherein the second cryptographic signature unambiguously identifies the adaptations of the field device made on the customer side as an application-specific intended state of the field device; and wherein, during the period of installation of the field device in the defined application, at least one validation or verification of the field device is performed on the customer side via the second cryptographic signature.

8. The method of claim 1,
wherein especially a customer-specific, system-specific, and/or device-specific signature are/is used as a second cryptographic signature.

9. The method of claim 1,
wherein a check is made, using the validation or verification of the field device, as to whether a respective actual state of the field device matches the intended state and the field device is intact, or whether an unauthorized change has been made to the hardware modules and/or the software modules of the field device.

10. The method of claim 1, wherein the first cryptographic signature and/or the second cryptographic signature are created via an asymmetric cryptosystem consisting of private key and a public verification key, a public key.

11. The method of claim 1, wherein electronic assemblies are identified as hardware modules.

12. The method of claim 1, wherein firmware or configuration parameters are identified as software modules.
